(19) United States
(12) Patent Application Publication
(10) Pub. No.: US 2015/0049122 A1
(43) Pub. Date: Feb. 19, 2015

(54) Display Apparatus Configured For Image Formation With Variable Subframes

(71) Applicant: Pixtronix, Inc., San Diego, CA (US)

(72) Inventors: Edward Buckley, Melrose, MA (US); Fahri Yaras, Chelsea, MA (US)

(73) Assignee: Pixtronix, Inc., San Diego, CA (US)

(21) Appl. No.: 13/970,399

(22) Filed: Aug. 19, 2013

(51) Int. Cl. G09G 3/20

(52) U.S. Cl. CPC G09G 3/2003
USPC 345/690

(57) ABSTRACT

This disclosure provides systems, methods, non-transitory computer readable media and apparatus for improving power efficiency of display devices. Control logic of a display device can reduce a number of subframes used to display a series of image frames. In some implementations, the control logic can detect a scene change in the series of image frames and reduce the number of subframes utilized for displaying a following image frame. Subsequently, the control logic can monotonically increase the number of subframes utilized for displaying a first set of successive image frames. In some implementations, the control logic may monotonically increase the number of subframes for a first set of image frames and then monotonically decrease the number of subframes for a second set of image frames.

### TECHNICAL FIELD

This disclosure relates to the field of displays, and in particular, to image formation processes used by displays.

### DESCRIPTION OF THE RELATED TECHNOLOGY

Electromechanical systems (EMS) devices include devices having electrical and mechanical elements, such as actuators, optical components (such as mirrors, shutters, and/or optical film layers) and electronics. EMS devices can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of deposited material layers, or that add layers to form electrical and electromechanical devices.

EMS-based display apparatus have been proposed that include display elements that modulate light by selectively moving a light blocking component into and out of an optical path through an aperture defined through a light blocking layer. Doing so selectively passes light from a backlight or reflects light from the ambient or a front light to form an image.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus including an input, subfield derivation logic, subframe generation logic and output logic. The input is capable of receiving image data associated with a series of image frames in a video sequence. The subfield derivation logic is capable of, for each of the image frames in the video sequence, deriving at least one color subfield, where each of the at least one color subfields for each image frame identifies a color intensity value with respect to each of a plurality of display elements in a display. The subframe generation logic is capable of generating a number of subframes for each of the color subfields derived from the image frames in the video sequence, where each generated subframe indicates the states of each of the plurality of display elements in the display. The output logic is capable of outputting to the subfield derivation logic and the subframe generation logic a number of subframes to generate for a first set of the image frames, and of controlling the timing of outputting the subframes generated by the subframe generation logic.

In some implementations, the apparatus further includes scene change detection logic capable of detecting a scene change within the video sequence, where the first set of image frames includes image frames immediately following a detected scene change. In some implementations, the output logic is capable of outputting a number of subframes to generate for a second set of the image frames. In some other implementations, the output logic is capable of outputting a number of subframes to generate equal to a full complement of subframes for a second set of image frames to be displayed subsequent to the display of the first set of image frames.

In some implementations, the subfield derivation logic is further capable of processing at least one color subfield, based on the number of subframes to generate output by the output control logic, to derive a processed color subfield, and the subframe generation logic is capable of generating subframes for the color subfield based on the processed color subfield. In some such implementations, processing the color subfield to derive a processed color subfield includes obtaining, for each color intensity value in the color subfield, an updated color intensity value based on the number of subframes to generate, and processing the updated color intensity values with an error distribution process to generate a set of spatially-dithered color intensity values.

In some implementations, the apparatus further includes a display including the input, the subfield derivation logic, the subframe generation logic and the output logic, a processor that is capable of communicating with the display, the processor being capable of processing image data and a memory device that is capable of communicating with the processor. In some implementations, the apparatus further includes a driver circuit capable of sending at least one signal to the display and a controller capable of sending at least a portion of the image data to the driver circuit. In some implementations, the apparatus further includes an image source module capable of sending the image data to the processor, where the image source module includes at least one of a receiver, transceiver and a transmitter, and an input device capable of receiving input data and to communicate the input data to the processor.

Another innovative aspect of the subject matter described in this disclosure can be implemented in a method of forming an image on a display. The method includes receiving image data associated with a series of image frames, deriving at least one color subfield for the respective image frames, where each of the at least one color subfields for each image frame identifies a color intensity value with respect to each of a plurality of light modulators in a display, generating a plurality of subframes for each of the at least one derived color subfields, where each generated subframe indicates the states of each of the plurality of light modulators in the display, and controlling the timing of outputting the number of subframes for the at least one color subfield.

In some implementations, the method further includes detecting a scene change in the series of image frames and selecting the first set of image frames from image frames following the detected scene change. In some implementations, the method further includes generating a full complement of subframes for a third set of image frames, in the series of image frames, to be displayed subsequent to the display of the first set of image frames.

In some implementations, the method includes processing at least one color subfield based on the number of subframes to derive a processed color subfield, where the processed color subfield includes processed color intensity values based on the number of subframes to generate, where generating the plurality of subframes for each of the at least one derived color subfields includes generating the plurality of subframes for each of the processed color subfields.

Another innovative aspect of the subject matter described in this disclosure can be implemented in a non-transitory computer readable storage medium having instructions encoded thereon, which when executed by a processor cause the processor to perform a method for displaying an image. The method includes receiving image data associated with a series of image frames, deriving at least one color subfield for the respective image frames, where each of the at least one color subfields for each image frame identifies a color intensity value with respect to each of a plurality of light modulators in a display, generating a plurality of subframes for each of the at least one derived color subfields, where each generated subframe indicates the states of each of the plurality of light modulators in the display, and controlling the timing of outputting the number of subframes for the at least one color subfield.

In some implementations, the method further includes detecting a scene change in the series of image frames and select the first set of image frames from image frames following the detected scene change. In some implementations, the method further includes generating a full complement of subframes for a third set of image frames, in the series of image frames, to be displayed subsequent to the display of the first set of image frames. In some implementations, the method further includes processing at least one color subfield based on the number of subframes to derive a processed color subfield, where the processed color subfield includes processed color intensity values based on the number of subframes to generate, and where generating the plurality of subframes for each of the at least one derived color subfields includes generating the plurality of subframes for each of the processed color subfields.

Details of one or more implementations of the subject matter described in this specification are set forth in the accompanying drawings and the description below. Although the examples provided in this summary are primarily described in terms of MEMS-based displays, the concepts provided herein may apply to other types of displays, such as liquid crystal displays (LCDs), organic light emitting diode (OLED) displays, electrophoretic displays, and field emission displays, as well as to other non-display MEMS devices, such as MEMS microphones, sensors, and optical switches. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIG. 3 shows a block diagram of an example display apparatus.

FIG. 4 shows a block diagram of example control logic suitable for use in the display apparatus shown in FIG. 3.

FIGS. 5-7 show flow diagrams of example processes for generating video images on a display.

FIGS. 8A and 8B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (such as e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

The human visual system (HVS) is less sensitive to fine details when viewing moving images. As a result, a display can have greater flexibility in the number of subframes it displays to reproduce a given image frame of video content than it does in reproducing still images. Accordingly, this flexibility can be leveraged to reduce the power consumption of a display. In some implementations, a display apparatus can be capable of displaying fewer subframes to reproduce image frames that are output shortly after a scene change in a video. The HVS takes time to orient to the new scene, and thus is less sensitive to the use of fewer subframes during this scene transition period. To mitigate image artifacts that might occur from a rapid change in the number of subframes used to output later image frames, the display apparatus can incrementally increase the number of subframes used to display successive image frames after a scene change up to a full complement of subframes.

In some other implementations, a display apparatus can be capable of continuously varying the number of subframes it uses to display image frames in video content in a periodic fashion, regardless of any image frame's temporal proximity to a scene change. For example, the display apparatus can be capable of displaying successive image frames in a video using increasing numbers of subframes over a first period of time, followed by displaying successive image frames with decreasing numbers of subframes over a second period of time.

Particular implementations of the subject matter described in this disclosure can be implemented to realize one or more of the following potential advantages. By displaying some image frames using fewer subframes, each of the implementations described above reduces the power consumed by a display in displaying video images. By reducing the number of subframes to be displayed, additional time is made available to display a remaining number of subframes. The additional time can be allocated to illuminating one or more of the remaining subframes. By increasing the amount of time for which the remaining subframes are illuminated, a backlight intensity used to illuminate these subframes can be reduced to a more energy efficient operating state, thereby reducing overall power consumption. In addition, additional power savings are reaped by avoiding having to expend the power needed to load a greater number of subframes into the display.

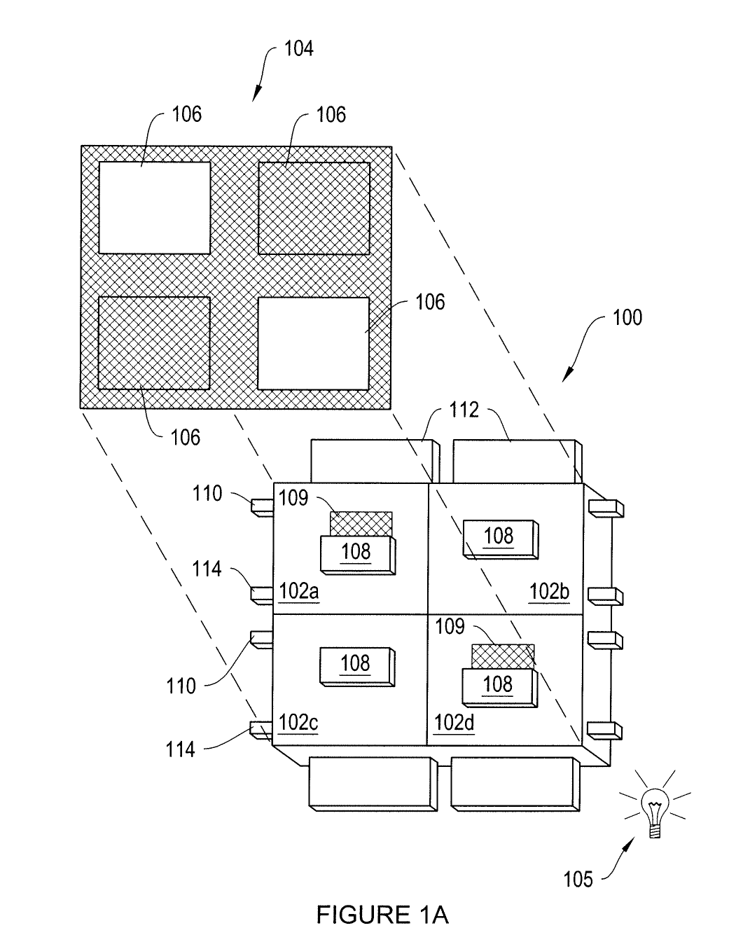

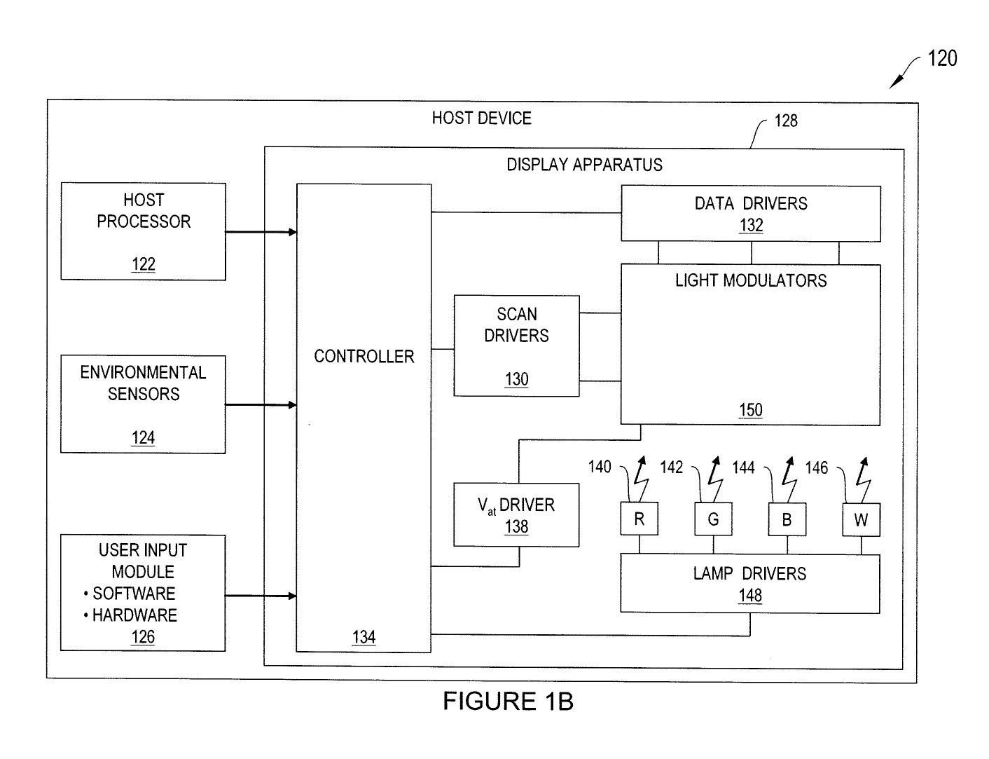

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the user sees the image by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent or glass substrates to facilitate a sandwich assembly arrangement where one substrate, containing the light modulators, is positioned over the backlight.

Each light modulator 102 can include a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix connected to the substrate and to the light modulators for controlling the movement of the shutters. The control matrix includes a series of electrical interconnects (such as interconnects 110, 112 and 114), including at least one write-enable interconnect 110 (also referred to as a scan-line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B shows a block diagram of an example host device 120 (i.e., cell phone, smart phone, PDA, MP3 player, tablet, e-reader, netbook, notebook, watch, etc.). The host device 120 includes a display apparatus 128, a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array 150 of display elements, such as the light modulators 102 shown in FIG. 1A. The scan drivers 130 apply write enabling voltages to scan-line interconnects 110. The data drivers 132 apply data voltages to the data interconnects 112.

In some implementations of the display apparatus, the data drivers 132 are configured to provide analog data voltages to the array 150 of display elements, especially where the luminance level of the image 104 is to be derived in analog fashion. In analog operation, the light modulators 102 are designed such that when a range of intermediate voltages is applied through the data interconnects 112, there results a range of intermediate open states in the shutters 108 and therefore a range of intermediate illumination states or luminance levels in the image 104. In other cases, the data drivers 132 are configured to apply only a reduced set of 2, 3 or 4 digital voltage levels to the data interconnects 112. These voltage levels are designed to set, in digital fashion, an open state, a closed state, or other discrete state to each of the shutters 108.

The scan drivers 130 and the data drivers 132 are connected to a digital controller circuit 134 (also referred to as the controller 134). The controller sends data to the data drivers 132 in a mostly serial fashion, organized in sequences, which may be predetermined, grouped by rows and by image frames. The data drivers 132 can include series to parallel data converters, level shifting, and for some applications digital to analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 114. In some other implementations, the common drivers 138, following commands from the controller 134, issue voltage pulses or signals to the array 150 of display elements, for instance global actuation pulses which are capable of driving and/or initiating simultaneous actuation of all display elements in multiple rows and columns of the array 150.

All of the drivers (such as scan drivers 130, data drivers 132 and common drivers 138) for different display functions are time-synchronized by the controller 134. Timing commands from the controller coordinate the illumination of red, green, blue and white lamps (140, 142, 144 and 146 respectively) via lamp drivers 148, the write-enabling and sequencing of specific rows within the array 150 of display elements, the output of voltages from the data drivers 132, and the output of voltages that provide for display element actuation. In some implementations, the lamps are light emitting diodes (LEDs).

The controller 134 determines the sequencing or addressing scheme by which each of the shutters 108 can be re-set to the illumination levels appropriate to a new image 104. New images 104 can be set at periodic intervals. For instance, for video displays, the color images 104 or frames of video are refreshed at frequencies ranging from 10 to 300 Hertz (Hz). In some implementations the setting of an image frame to the array 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green, blue and white.

In some implementations, where the display apparatus 100 is designed for the digital switching of shutters 108 between open and closed states, the controller 134 forms an image by the method of time division grayscale, as previously described. In some other implementations, the display apparatus 100 can provide grayscale through the use of multiple shutters 108 per pixel.

In some implementations, the data for an image 104 state is loaded by the controller 134 to the display element array 150 by a sequential addressing of individual rows, also referred to as scan lines. For each row or scan line in the sequence, the scan driver 130 applies a write-enable voltage to the write enable interconnect 110 for that row of the array 150, and subsequently the data driver 132 supplies data voltages, corresponding to desired shutter states, for each column in the selected row. This process repeats until data has been loaded for all rows in the array 150. In some implementations, the sequence of selected rows for data loading is linear, proceeding from top to bottom in the array 150. In some other implementations, the sequence of selected rows is pseudo-randomized, in order to minimize visual artifacts. And in some other implementations, the sequencing is organized by blocks, where, for a block, the data for only a certain fraction of the image 104 state is loaded to the array 150, for instance by addressing only every 5^{th} row of the array 150 in sequence.

In some implementations, the process for loading image data to the array 150 is separated in time from the process of actuating the display elements in the array 150. In these implementations, the display element array 150 may include data memory elements for each display element in the array 150 and the control matrix may include a global actuation interconnect for carrying trigger signals, from common driver 138, to initiate simultaneous actuation of shutters 108 according to data stored in the memory elements.

In alternative implementations, the array 150 of display elements and the control matrix that controls the display elements may be arranged in configurations other than rectangular rows and columns. For example, the display elements can be arranged in hexagonal arrays or curvilinear rows and columns. In general, as used herein, the term scan-line shall refer to any plurality of display elements that share a write-enabling interconnect.

The host processor 122 generally controls the operations of the host. For example, the host processor 122 may be a general or special purpose processor for controlling a portable electronic device. With respect to the display apparatus 128, included within the host device 120, the host processor 122 outputs image data as well as additional data about the host. Such information may include data from environmental sensors, such as ambient light or temperature; information about the host, including, for example, an operating mode of the host or the amount of power remaining in the host's power source; information about the content of the image data; information about the type of image data; and/or instructions for display apparatus for use in selecting an imaging mode.

The user input module 126 conveys the personal preferences of the user to the controller 134, either directly, or via the host processor 122. In some implementations, the user input module 126 is controlled by software in which the user programs personal preferences such as deeper color, better contrast, lower power, increased brightness, sports, live action, or animation. In some other implementations, these preferences are input to the host using hardware, such as a switch or dial. The plurality of data inputs to the controller 134 direct the controller to provide data to the various drivers 130, 132, 138 and 148 which correspond to optimal imaging characteristics.

An environmental sensor module 124 also can be included as part of the host device 120. The environmental sensor module 124 receives data about the ambient environment, such as temperature and or ambient lighting conditions. The sensor module 124 can be programmed to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

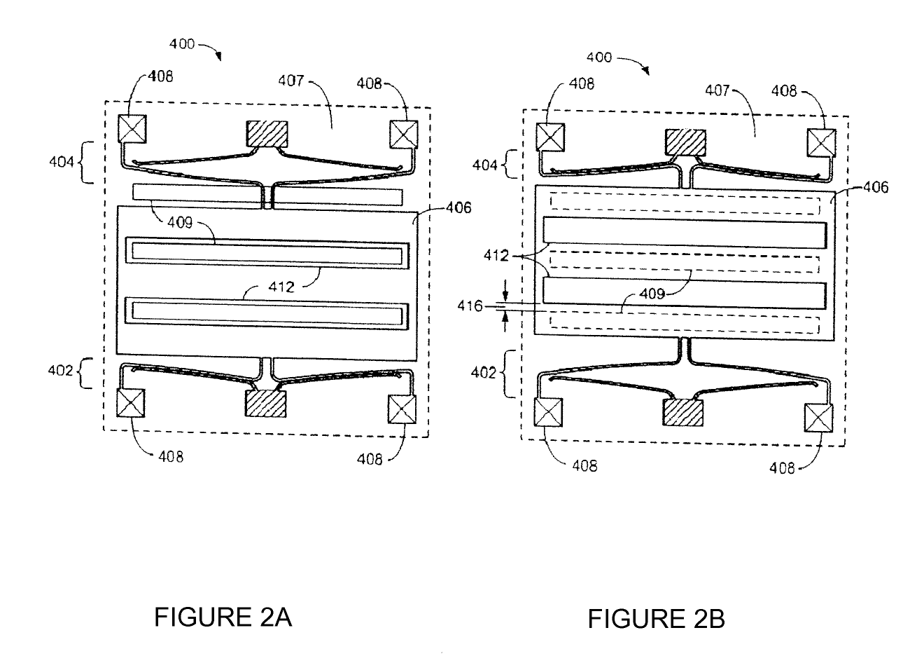

FIGS. 2A and 2B show views of an example dual actuator shutter assembly 400. The dual actuator shutter assembly 400, as depicted in FIG. 2A, is in an open state. FIG. 2B shows the dual actuator shutter assembly 400 in a closed state. The shutter assembly 400 includes actuators 402 and 404 on either side of a shutter 406. Each actuator 402 and 404 is independently controlled. A first actuator, a shutter-open actuator 402, serves to open the shutter 406. A second opposing actuator, the shutter-close actuator 404, serves to close the shutter 406. Both of the actuators 402 and 404 are compliant beam electrode actuators. The actuators 402 and 404 open and close the shutter 406 by driving the shutter 406 substantially in a plane parallel to an aperture layer 407 over which the shutter is suspended. The shutter 406 is suspended a short distance over the aperture layer 407 by anchors 408 attached to the actuators 402 and 404. The inclusion of supports attached to both ends of the shutter 406 along its axis of movement reduces out of plane motion of the shutter 406 and confines the motion substantially to a plane parallel to the substrate.

The shutter 406 includes two shutter apertures 412 through which light can pass. The aperture layer 407 includes a set of three apertures 409. In FIG. 2A, the shutter assembly 400 is in the open state and, as such, the shutter-open actuator 402 has been actuated, the shutter-close actuator 404 is in its relaxed position, and the centerlines of the shutter apertures 412 coincide with the centerlines of two of the aperture layer apertures 409. In FIG. 2B the shutter assembly 400 has been moved to the closed state and, as such, the shutter-open actuator 402 is in its relaxed position, the shutter-close actuator 404 has been actuated, and the light blocking portions of the shutter 406 are now in position to block transmission of light through the apertures 409 (depicted as dotted lines).

Each aperture has at least one edge around its periphery. For example, the rectangular apertures 409 have four edges. In alternative implementations in which circular, elliptical, oval, or other curved apertures are formed in the aperture layer 407, each aperture may have only a single edge. In some other implementations, the apertures need not be separated or disjoint in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through apertures 412 and 409 in the open state, it is advantageous to provide a width or size for shutter apertures 412 which is larger than a corresponding width or size of apertures 409 in the aperture layer 407. In order to effectively block light from escaping in the closed state, it is preferable that the light blocking portions of the shutter 406 overlap the apertures 409. FIG. 2B shows an overlap 416, which in some implementations can be predefined, between the edge of light blocking portions in the shutter 406 and one edge of the aperture 409 formed in the aperture layer 407.

The electrostatic actuators 402 and 404 are designed so that their voltage-displacement behavior provides a bi-stable characteristic to the shutter assembly 400. For each of the shutter-open and shutter-close actuators there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vₘ.

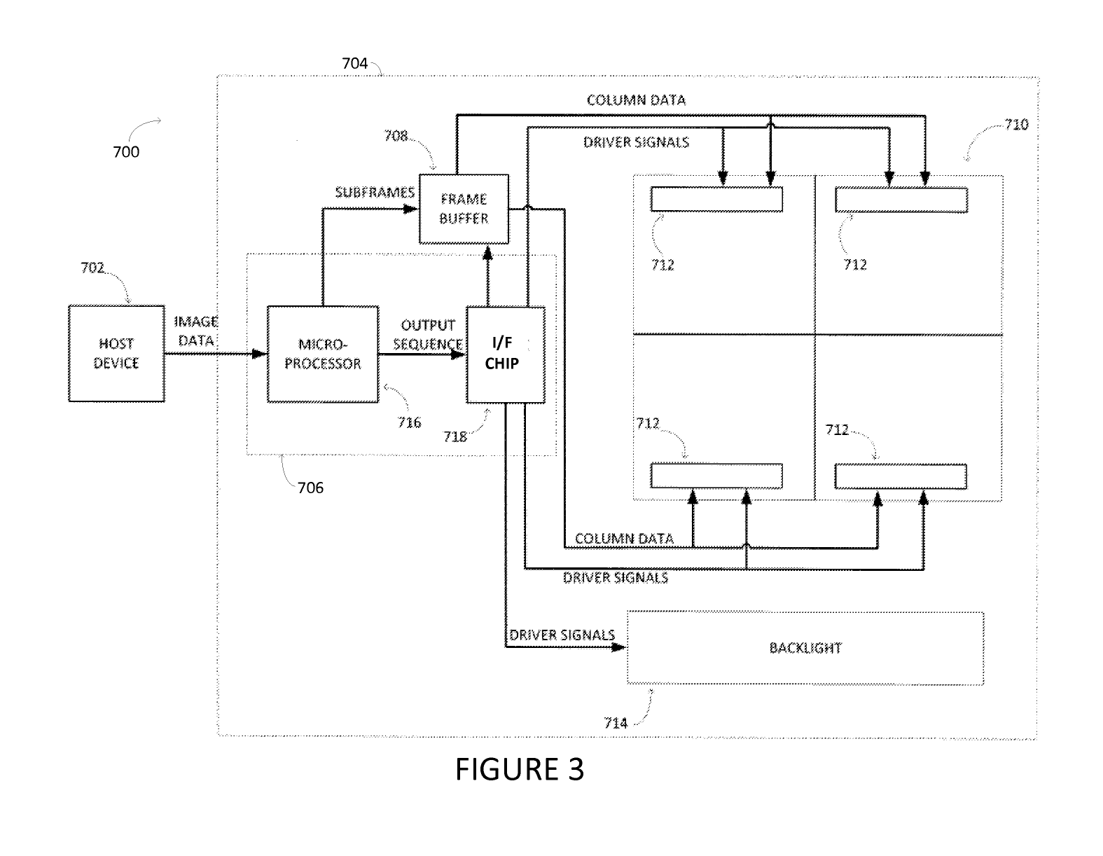

FIG. 3 shows a block diagram of an example display apparatus 700. The display apparatus 700 includes a host device 702 and a display module 704. The host device can be any of a number of electronic devices, such as a portable telephone, a smartphone, a watch, a tablet computer, a laptop computer, a desktop computer, a television, a set top box, a DVD or other media player, or any other device that provides graphical output to a display. In general, the host device 702 serves as a source for image data to be displayed on the display module 704.

The display module 704 further includes control logic 706, a frame buffer 708, an array of display elements 710, display drivers 712 and a backlight 714. In general, the control logic 706 serves to process image data received from the host device 702 and controls the display drivers 712, array of display elements 710 and backlight 714 to together produce the images encoded in the image data.

In some implementations, as shown in FIG. 3, the functionality of the control logic 706 is divided between a microprocessor 716 and an interface (I/F) chip 718. In some implementations, the interface chip 718 is implemented in an integrated circuit logic device, such as an application specific integrated circuit (ASIC). In some implementations, the microprocessor 716 is configured to carry out all or substantially all of the image processing functionality of the control logic 706. In addition, the microprocessor 716 can be configured to determine an appropriate output sequence for the display module 704 to use to generate received images. For example, the microprocessor 716 can be configured to convert image frames included in the received image data into a set of image subframes. Each image subframe can be associated with a color and a weight, and includes desired states of each of the display elements in the array of display elements 710. The microprocessor 716 also can be configured to determine the number of image subframes to display to produce a given image frame, the order in which the image subframes are to be displayed, and parameters associated with implementing the appropriate weight for each of the image subframes. These parameters may include, in various implementations, the duration for which each of the respective image subframes is to be illuminated and the intensity of such illumination. These parameters (i.e., the number of subframes, the order and timing of their output, and the weight implementation parameters for each subframe) can be collectively referred to as an “output sequence.”

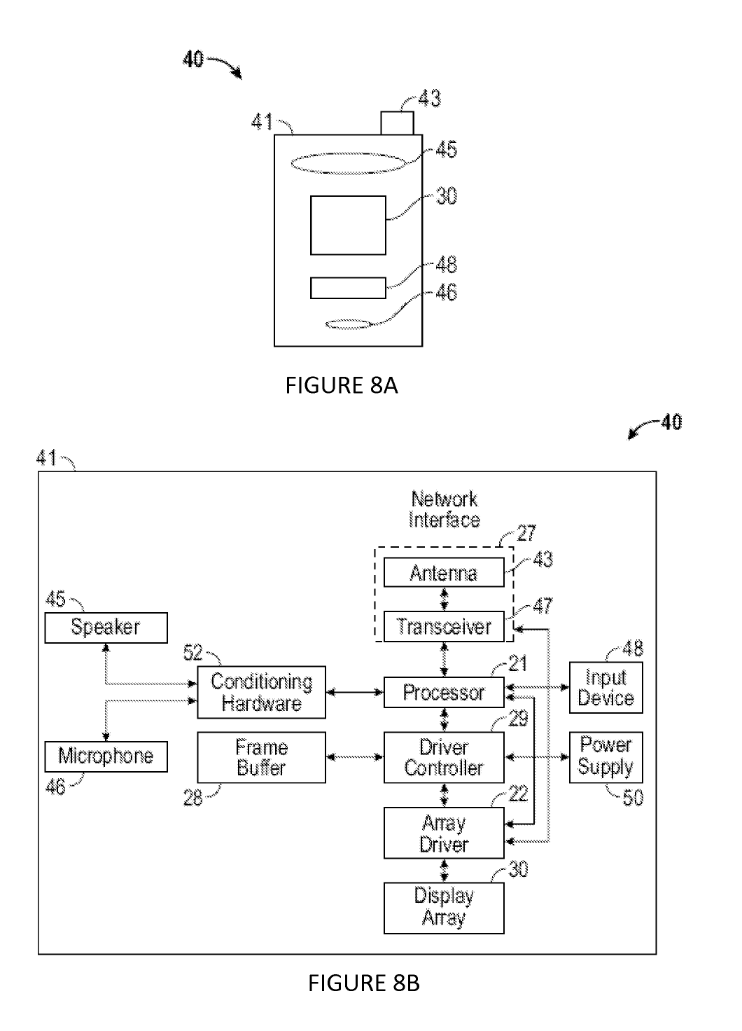

The interface chip 718 can be configured to carry out more routine operations of the display module 704. The operations may include retrieving image subframes from the frame buffer 708 and outputting control signals to the display drivers 712 and the backlight 714 in response to the retrieved image subframe and the output sequence determined by the microprocessor 716. The frame buffer 708 can be any volatile or non-volatile integrated circuit memory, such as DRAM, high-speed cache memory, or flash memory (for example, the frame buffer 708 can be similar to the frame buffer 28 shown in FIG. 8B). In some other implementations, the interface chip 718 causes the frame buffer 708 to output data signals directly to the display drivers 712.

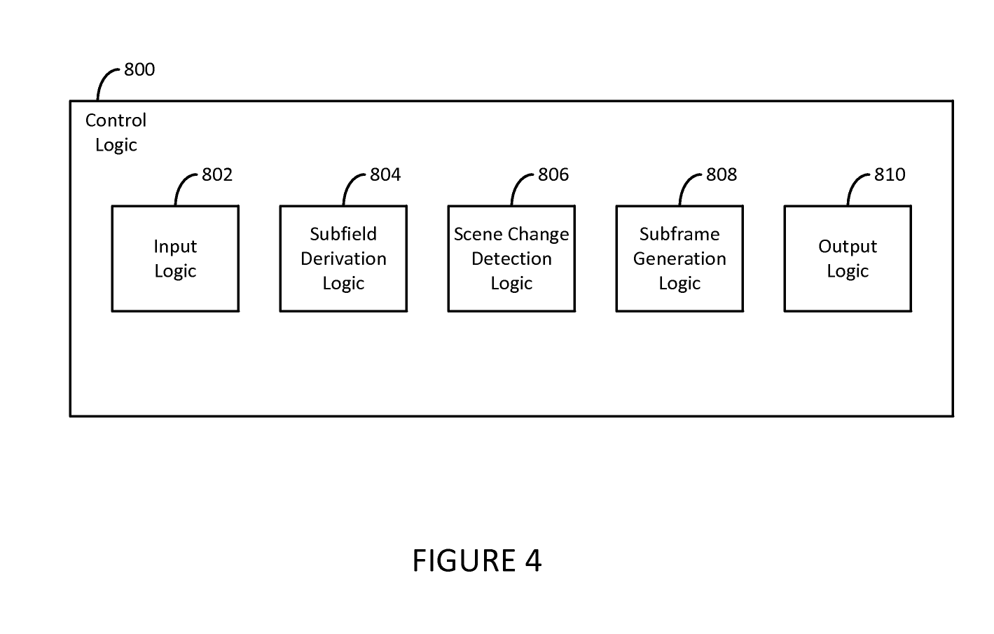

In some other implementations, the functionality of the microprocessor 716 and the interface chip 718 are combined into a single logic device, which may take the form of a microprocessor, an ASIC, a field programmable gate array (FPGA) or other programmable logic device. For example, the functionality of the microprocessor 716 and the interface chip 718 can be implemented by a processor 21 shown in FIG. 8B. In some other implementations, the functionality of the microprocessor 716 and the interface chip 718 may be divided in other ways between multiple logic devices, including one or more microprocessors, ASICs, FPGAs, digital signal processors (DSPs) or other logic devices. The functionality of the control logic 706 is described further below in relation to FIGS. 4-6.

The array of display elements 710 can include an array of any type of display elements that can be used for image formation. In some implementations, the display elements can be EMS light modulators. In some such implementations, the display elements can be MEMS shutter-based light modulators similar to those shown in FIGS. 2A or 2B. In some other implementations, the display elements can be other forms of light modulators, including liquid crystal light modulators, other types of EMS based light modulators, or light emitters, such as OLED emitters, configured for use with a time division gray scale image formation process.

The display drivers 712 can include a variety of drivers depending on the specific control matrix used to control the display elements in the array of display elements 710. In some implementations, the display drivers 712 include a plurality of scan drivers similar to the scan drivers 130, a plurality of data drivers similar to the data drivers 132, and a set of common drivers similar to the common drivers 138, all shown in FIG. 1B. As described above, the scan drivers output write enabling voltages to rows of display elements, while the data drivers output data signals along columns of display elements. The common drivers output signals to display elements in multiple rows and multiple columns of display elements.

In some implementations, particularly for larger display modules 704, the control matrix used to control the display elements in the array of display elements 710 is segmented into multiple regions. For example, the array of display elements 710 shown in FIG. 3 is segmented into four quadrants. A separate set of display drivers 712 is coupled to each quadrant. Dividing a display into segments in this fashion reduces the propagation time needed for signals output by the display drivers to reach the furthest display element coupled to a given driver, thereby decreasing the time needed to address the display. Such segmentation also can reduce the power requirements of the drivers employed.

In some implementations, the display elements in the array of display elements can be utilized in a direct-view transmissive display. In direct-view transmissive displays, the display elements, such as EMS light modulators, selectively block light that originates from a backlight, which is illuminated by one or more lamps. Such display elements can be fabricated on transparent substrates, made, for example, from glass. In some implementations, the display drivers 712 are coupled directly to the glass substrate on which the display elements are formed. In such implementations, the drivers are built using a chip-on-glass configuration. In some other implementations, the drivers are built on a separate circuit board and the outputs of the drivers are coupled to the substrate using, for example, flex cables or other wiring.

The backlight 714 can include a light guide, one or more light sources (such as LEDs) and light source drivers. The light sources can include light sources of multiple primary colors, such as red, green, blue, and in some implementations white. The light source drivers are configured to individually drive the light sources to a plurality of discrete light levels to enable illumination gray scale and/or content adaptive backlight control (CABC) in the backlight. The light guide distributes the light output by light sources substantially evenly beneath the array of display elements 710. In some other implementations, for example for displays including reflective display elements, the display apparatus 700 can include a front light or other form of lighting instead of a backlight. The illumination of such alternative light sources can likewise be controlled according to illumination grayscale processes that incorporate content adaptive control features. For ease of explanation, the display processes discussed herein are described with respect to the use of a backlight. However, it would be understood by a person of ordinary skill that such processes also may be adapted for use with a front light or other similar form of display lighting.

FIG. 4 shows a block diagram of example control logic 800 suitable for use as the control logic 706 in the display apparatus 700 shown in FIG. 3. More particularly, FIG. 4 shows a block diagram of functional modules executed by the microprocessor 716. Each functional module can be implemented as software in the form of computer executable instructions stored on a tangible computer readable medium, which can be executed by the microprocessor 716. The control logic 800 includes input logic 802, subfield derivation logic 804, scene change detection logic 806, subframe generation logic 808 and output logic 810. While shown as separate functional modules in FIG. 4, in some implementations, the functionality of two or more of the modules may be combined into one or more larger, more comprehensive modules.

In some implementations, when executed by the microprocessor 716, the components of the control logic 800, along with the interface chip 718, display drivers 712, and backlight 714 (all shown in FIG. 3), function to carry out a method for generating an image on a display.

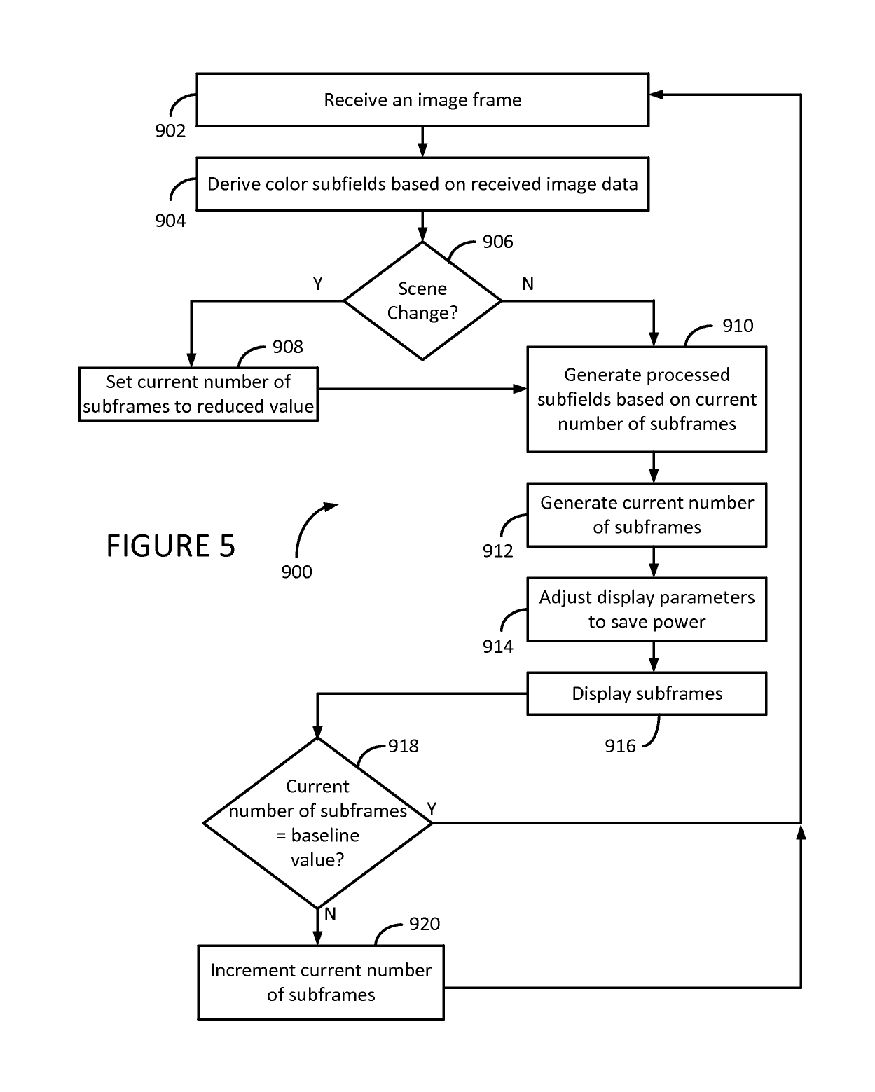

FIG. 5 shows a flow diagram of a first example process 900 for generating video images on a display. The process 900 includes receiving image data associated with an image frame (stage 902); deriving color subfields based on received image data (stage 904); detecting a scene change (906); and setting a current number of subframes to a reduced value if a scene change is detected (stage 908). The process 900 further includes generating processed subfields, if necessary, based on the current number of subframes (stage 910); generating the current number of subframes (stage 912); adjusting display parameters to save power (stage 914); displaying the current number of subframes (stage 916); determining whether the current number of subframes is equal to a baseline number of subframes (stage 918); and increasing the current number of subframes (stage 920).

Referring to FIGS. 3-5, the process 900 begins with the input logic 802 receiving image data in the form of an image frame (stage 902). Typically, image data for the received image frame includes a stream of intensity values for the red, green, and blue components of each pixel in the image frame. In some implementations, image data for the received image frame may include a stream of intensity values for the cyan, magenta, yellow, and black components of each pixel in the image frame. In some other implementations, the image frame may include a stream of intensity values for other color models, such as L*a*b*, XYZ tristimulus, raw tristimulus, etc. The intensity values typically are received as binary numbers.

The subfield derivation logic 804 derives and stores a set of color subfields for each image frame based on the received image data (stage 904). Each color subfield includes for each pixel in the display an intensity value indicating the amount of light to be transmitted by that pixel, for that color, to form the image frame. In some implementations, the subfield derivation logic 804 derives the set of color subfields by segregating the pixel intensity values for each primary color represented in the received image data (i.e., red, green and blue). In some other implementations, the subfield derivation logic 804 processes the received image data further to derive color subfields for one or more primary colors other than those represented in the image data. For example, the subfield derivation logic 804 may derive a white, cyan, yellow, or magenta subfield, or a subfield for another color that can be formed through illumination of a combination of two or more of the display light sources. Light energy assigned to this additional subfield is subtracted from the color subfields associated with the input colors. In some implementations, one or more image preprocessing stages, such as gamma correction, also may be carried out by the subfield derivation logic 804 prior to or in the process of deriving the image subfields. In some implementations, the color subfields are derived based on a number of subframes to be utilized to display the image frame. For example, if a time division gray scale technique is used to display the image frame, then the derived color subfields are generated based on the number of subframes specified to display the image frame. In some implementations, the output logic 810 can specify a baseline value for the number of subframes, which can be equal to the largest allowable number of subframes utilized to display the image frame for a given operating mode.

The scene change detection logic 806 detects a scene change in the received image frame (stage 906). Scene change detection logic 806 can utilize various methods for detecting scene change between image frames. In some implementations, the scene detection logic 806 can measure inter-frame differences to detect a scene change. For example, in some implementations, the scene detection logic 806 can utilize template matching, in which sets of pixels of two successive image frames at corresponding locations are compared to detect a scene change. In some implementations, the scene change logic can compare color histograms of the current image frame to that of one or more previous image frames to determine scene change. In some such implementations, the scene detection logic 806 can generate a color histogram representing a distribution of pixel intensity values in the received image frame over the color spectrum. The scene detection logic 806 also can maintain a color histogram corresponding to an earlier image frame.

The scene detection logic 806 can detect a scene change by detecting changes in the pixel intensity value distributions corresponding to the received image frame and the earlier image frame. In some implementations, the scene detection logic 806 can maintain a color histogram that is an aggregate of color histograms of more than one earlier image frame(s). A scene change can then be detected by detecting changes in the intensity distribution of the aggregate color histogram from the color histogram of the received image frame. In some implementations, the scene detection logic 806 can generate color subfield histograms of each color subfield of an image frame. For example, color subfield histograms for each of the four color subfields, red, green, blue and white can be generated for the received image frame. In some such implementations, the detection of a scene change can be a function of collective changes in distributions of pixel intensity values across the multiple color subfield histograms. Other known methods of detecting scene change also may be employed. Upon detecting a scene change, the scene change detection logic 806 can communicate to the output logic 810 that a scene change was detected.

The output logic 810, upon receiving an indication from the scene change detection logic 806 that a scene change has occurred, sets a current number of subframes to a reduced value (stage 908). The current number of subframes indicates the number of subframes that will be utilized for displaying the received image frame. The output logic 810 sets the current number of subframes to a reduced value, which, as discussed further below, allows the output logic to reduce power consumption. The reduced value can be a value that is less than the baseline value.

The subfield derivation logic 804 processes each derived color subfield based on the current number of subframes and generates processed color subfields (stage 910). If a scene change is detected in the received image frame (stage 906), the current number of subframes can be equal to the reduced value. If a scene change is not detected (stage 906), then the current number of subframe may be equal to any value between and including the reduced value and the baseline value.

In some implementations, the subfield derivation logic 804 quantizes color intensity values to an intensity scale that matches the current number of subframes used. For example, in some implementations, which utilize time division gray scale techniques, both the intensity scale and the resolution corresponding to a baseline number of subframes can be greater than the intensity scale and the resolution corresponding to a reduced number of subframes. As the current number of subframes generally varies between the reduced value and the baseline value, the subfield derivation logic 804 determines the appropriate intensity scale and resolution to be used for the current number of subframes. Using a smaller intensity scale and lower resolution may introduce quantization errors in the determination of processed subfields. In some implementations, the subfield generation logic may utilize error distribution or dithering algorithms to diffuse such quantization errors. The error distribution algorithm, in such implementations, may distribute the error by changing the pixel values of pixels in the vicinity of the affected pixel. In some implementations, the subfield generation logic 804 can use dithering algorithms such as Floyd-Steinberg error diffusion algorithm, block quantization and/or ordered dithering algorithms, and other spatially dithering algorithms, or variants thereof, for spatially dithering the image frame.

The processed color subfields can be passed on to the subframe generation logic 808 for generating the specified number of subframes (stage 912). The subframe generation logic 808 generates the number of subframes for each image frame based on the current number of subframes and the processed color subfield. For example, if the current number of subframes is equal to 16, the subframe generation logic 808 can generate 4 subframes for each of the red, green, blue and white processed subfields for the image frame. In some implementations, to generate the current number of subframes, the subframe generation logic 808 can use a code-word lookup table (LUT) to obtain a series of display element states for each pixel based on the intensity values indicated in the processed color subfields. In some implementations, the states for a pixel can include an OPEN state, a CLOSED state and one or more partially OPEN states of a light modulator included in the pixel. After generating the subframes, the subframe generation logic 808 can send the generated number of subframes to the output logic 810.

The output logic 810 can adjust display parameters to save power (stage 914). In some implementations, reducing the number of subframes to be displayed can result in unused time during an image frame. This unused time can be harvested by the output logic 810 to adjust display parameters. For example, in some implementations, the harvested time can be used to increase the duration for which one or more of the subframes are illuminated. This allows the output logic 810 to reduce the illumination intensity of the backlight, and therefore reduce the power consumed during the illumination period of the increased-duration subframes. The illumination intensity of the backlight is reduced to an intensity that produces the desired pixel intensity value for that subfield. In this manner, the power consumption of the backlight is reduced while at the same time the pixel intensity value is substantially maintained at the desired value. In some such implementations, the output logic 810 may equally distribute the harvested time among the subframes. In some other such implementations, the output logic 810 may unequally distribute the harvested time among the subframes. The output logic 810 can subsequently output the generated subframes to the display for presentation of the image frame (stage 916).

The process 900 also includes determining if the current number of subframes has reached the baseline value (stage 918). If the baseline value is not reached, the output logic 810 increments the current number of subframes to display (stage 920). However, if the baseline value is reached, the current number of subframes is not changed. The process continues as the input logic 802 receives the next image frame. In some implementations, the output logic 810 can increment the current number of subframes in a monotonic manner.

The process 900, in the above manner, causes a processor within the display to receive a series of image frames, and display each image frame with a corresponding current number of subframes. If a scene change is detected (as in stage 906), the number of subframes utilized for displaying subsequent received image frames is reduced and then monotonically increased.

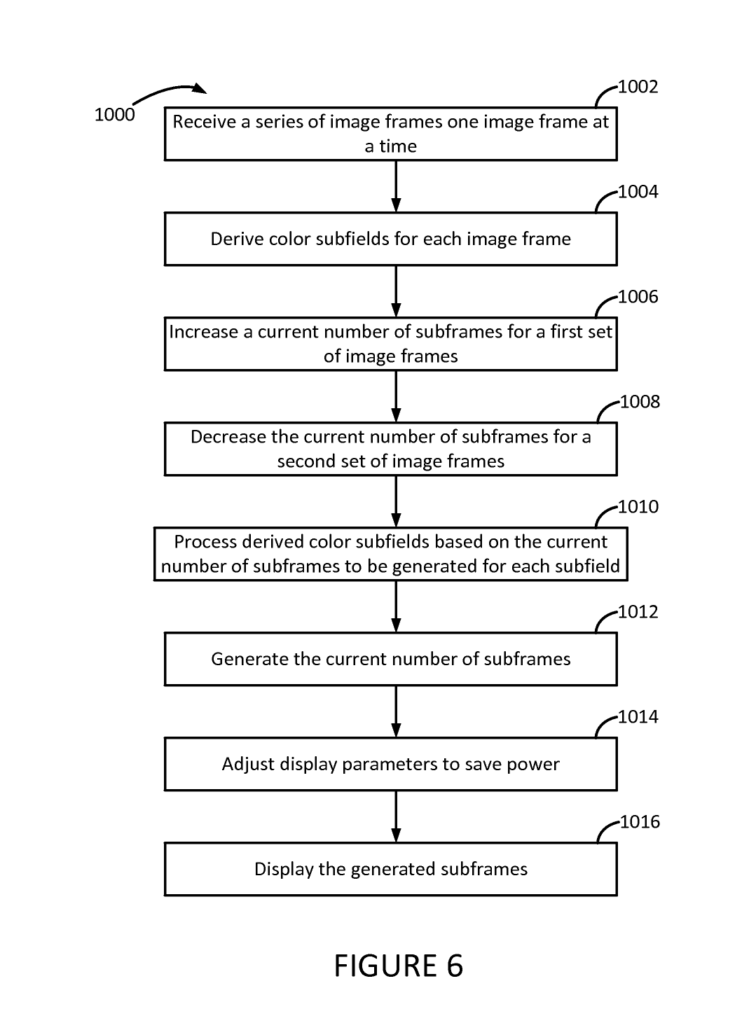

Table 1, below shows one example of the manner in which an example series of image frames is processed by the process 900 shown in FIG. 6. The example series of image frames includes 16 image frames occurring after a scene change. The image frames are listed in the leftmost column and are numbered from 1 to 16, where image frame no. 1 is the first image frame of a new scene.

TABLE 1

| Image | Red | Green | Blue | White | Current |
|---|---|---|---|---|---|
| frame | subfield | subfield | subfield | subfield | no. of |
| no. | subframes | subframes | subframes | subframes | subframes |
| 1 | 4 | 4 | 4 | 5 | 17 |
| 2 | 4 | 5 | 4 | 5 | 18 |
| 3 | 5 | 5 | 4 | 5 | 19 |
| 4 | 5 | 5 | 5 | 5 | 20 |
| 5 | 5 | 6 | 5 | 5 | 21 |
| 6 | 6 | 6 | 5 | 5 | 22 |
| 7 | 6 | 6 | 6 | 5 | 23 |
| 8 | 6 | 7 | 6 | 5 | 24 |
| 9 | 7 | 7 | 6 | 5 | 25 |
| 10 | 7 | 7 | 7 | 5 | 26 |
| 11 | 7 | 8 | 7 | 5 | 27 |
| 12 | 8 | 8 | 7 | 5 | 28 |
| 13 | 8 | 8 | 8 | 5 | 29 |
| 14 | 8 | 9 | 8 | 5 | 30 |
| 15 | 9 | 9 | 8 | 5 | 31 |
| 16 | 9 | 9 | 9 | 5 | 32 |

Table 1 also shows the number of subframes used for each of four color subfields: red, green, blue and white, derived for each image frame. Furthermore, in the rightmost column, Table 1 shows the values of the current number of subframes displayed for an image frame referred to in relation to the process 900, above. The current number of subframes is the sum of the number of subframes utilized for each of the four color subfields. In some implementations, the value (17) of the current number of subframes indicated for the image frame no. 1 corresponds to the reduced value. In some implementations, the value (32) of the current number of subframes indicated for the image frame no. 16 corresponds to the baseline value. As shown in Table 1, after a scene change, the output logic 810 monotonically increases the current number of subframes utilized for displaying an image frame from 17 to 32.

In some implementations, the output logic 810 also monotonically increases the number of subframes utilized in displaying each color subfield from a first number of subframes to a second number of subframes. For example, for each of the red, green and blue subfields, the output logic 810 monotonically increases the number of subframes from 4 subframes for image frame no. 1 to 9 subframes for image frame no. 16. In some implementations, the number of subframes for the white subfield is maintained constant at 5 subframes for all image frames 1-16. In some other implementations, the number of subframes for the white subfield also can be monotonically increased.

In some implementations, the number of subframes for only some of the subfields may be increased from one image frame to the next. For example, as shown in Table 1, the number of subframes for only the green subfield is increased (from 4 subframes to 5 subframes) from image frame no. 1 to image frame no. 2. In some other implementations, the number of subframes for all the subfields may be increased simultaneously from one image frame to the next. In some other implementations, the current number of subframes may remain the same during display of some image frames, but then increase during the display of one or more subsequent image frames. For example, the current number of subframes may remain constant at 19 for five image frames, and then increase by, for example, 1 to 20 during the next three image frames. In this manner, an overall monotonic increase in the current number of subframes is achieved over the nine image frames despite the current number of subframes remaining unchanged over the first five image frames.

In some implementations, the current number of subframes used from one image frame to the next may be incremented by only one subframe. For example, as shown in Table 1, the number of subframes for any image frame to the next image frame increases by only one subframe. In some other implementations, number of subframes may be incremented by more than one subframe from one image frame to the next image frame.

In some implementations, the number of subframes for one color subfield may be increased at a faster rate than that for another color subfield. For example, in some implementations, the rate at which the number of subframes for the red and blue subfields is increased may be greater than the rate at which the subframes for the color green subfield are increased. Varying the rate of increase in the subframes for different color subfields may be utilized to match the properties of the human visual system.

In some implementations, the output logic 810 can revert to output a full complement of subframes for image frames displayed after image frame no. 16 shown in Table 1. In some implementations, the full complement of subframe can be equal to the baseline value.

FIG. 6 shows a flow diagram of another example process 1000 for generating an image on a display. The process 1000 includes receiving a series of image frames one image frame at a time (stage 1002); deriving color subfields for each image frame (stage 1004); increasing a current number of subframes for a first set of image frames (stage 1006); decreasing the current number of subframes for a second set of image frames (stage 1008); processing the derived color subfields based on the current number of subframes to be generated for each subfield (stage 1010); generating the current number of subframes for each image frame (stage 1012); adjusting display parameters to save power (stage 1014); and outputting generated subframes for display (stage 1016).

The process 1000 shown in FIG. 6 is similar to the process 900 shown in FIG. 5 in that the both the processes manipulate the number of subframes to be displayed during a series of image frames. However, unlike the process 900, in which the current number of subframes is first reduced and then monotonically increased after a scene change, the process 1000 varies the current number of subframes regardless of a scene change. More particularly, in process 1000, the current number of subframes are monotonically increased for a first set of image frames, and then monotonically decreased for a second set of subframes. Furthermore, the monotonic increase and decrease of the current number of subframes can be periodically repeated.

The process 1000 begins by receiving the series of image frames one image frame at a time (stage 1002). The input logic 802 receives each of the series of image frames. As discussed above in relation to stage 902 of process 900 shown in FIG. 5, the image data associated with each image frame includes a stream of intensity values for the, e.g., red, green and blue components of each pixel in the image frame.

After receiving each image frame, the subfield derivation logic 804 derives color subfields for each image frame (stage 1004). Deriving color subfields for each frame is similar to deriving color subfields for each image frame discussed above in relation to process 900 shown in FIG. 5.

The process 1000 also includes increasing the current number of subframes for a first set of image frames (stage 1006) and decreasing the current number of subframes for a second set of image frames (stage 1008). In some implementations, the increasing and the decreasing of the current number of subframes can be carried out monotonically. One example of the manner in which the number of subframes is increased and decreased is shown below in Table 2. As shown in Table 2, the current number of subframes is monotonically increased (from 17 to 32) for a first set of 16 image frames (i.e., image frame no. 1 to image frame no. 16), and then monotonically decreased (from 32 to 17) for a second set of next 16 image frames (i.e., image frame no. 17 to image frame no. 31). A person having ordinary skill in the art will readily understand that the values of the current number of subframes shown in Table 2 between which the number of subframes is increased and decreased are only example values.

TABLE 2

| Image | Red | Green | Blue | White | Current |
|---|---|---|---|---|---|
| frame | subfield | subfield | subfield | subfield | no. of |
| no. | subframes | subframes | subframes | subframes | subframes |
| 1 | 4 | 4 | 4 | 5 | 17 |
| 2 | 4 | 5 | 4 | 5 | 18 |
| 3 | 5 | 5 | 4 | 5 | 19 |
| 4 | 5 | 5 | 5 | 5 | 20 |
| 5 | 5 | 6 | 5 | 5 | 21 |
| 6 | 6 | 6 | 5 | 5 | 22 |
| 7 | 6 | 6 | 6 | 5 | 23 |
| 8 | 6 | 7 | 6 | 5 | 24 |
| 9 | 7 | 7 | 6 | 5 | 25 |
| 10 | 7 | 7 | 7 | 5 | 26 |
| 11 | 7 | 8 | 7 | 5 | 27 |
| 12 | 8 | 8 | 7 | 5 | 28 |
| 13 | 8 | 8 | 8 | 5 | 29 |
| 14 | 8 | 9 | 8 | 5 | 30 |
| 15 | 9 | 9 | 8 | 5 | 31 |
| 16 | 9 | 9 | 9 | 5 | 32 |
| 17 | 9 | 9 | 8 | 5 | 31 |
| 18 | 8 | 9 | 8 | 5 | 30 |
| 19 | 8 | 8 | 8 | 5 | 29 |
| 20 | 8 | 8 | 7 | 5 | 28 |
| 21 | 7 | 8 | 7 | 5 | 27 |
| 22 | 7 | 7 | 7 | 5 | 26 |
| 23 | 7 | 7 | 6 | 5 | 25 |
| 24 | 6 | 7 | 6 | 5 | 24 |
| 25 | 6 | 6 | 6 | 5 | 23 |
| 26 | 6 | 6 | 5 | 5 | 22 |
| 27 | 5 | 6 | 5 | 5 | 21 |
| 28 | 5 | 5 | 5 | 5 | 20 |
| 29 | 5 | 5 | 4 | 5 | 19 |
| 30 | 4 | 5 | 4 | 5 | 18 |
| 31 | 4 | 4 | 4 | 5 | 17 |

In some implementations, the number of image frames in the first set of image frames (for which the current number of subframes are monotonically increased) can be equal to the number of image frames in the second set of image frames (for which the current number of subframes are monotonically decreased). For example, as shown in Table 2, the current number of subframes is monotonically increased for 16 image frames (image frame no. 1 to image frame no. 16), the same number of image frames (image frame no. 17 to image frame no. 31) for which the current number of subframes is monotonically decreased. In some other implementations, the number of image frames in the first set of image frames may be different from the number of image frames in the second set of image frames.

For each image frame, the subfield derivation logic 804 processes each derived color subfield based on the current number of subframes that are to be generated and displayed for the image frame and generate processed subfields (stage 1010). For example, referring to Table 2, the subfield derivation logic 804 can process derived red, green, blue and white subfields for each of the image frames 1-31 to provide corresponding processed subfields based on the current number of subframes. The subfield derivation logic 804 also may implement error distribution and dithering algorithms, discussed above, for generating the processed subfields. The processed subfields can include processed pixel intensity values for each pixel in the image frame. The processed subfields can be communicated to the subframe generation logic 806.

The subframe generation logic 806, in a manner similar to that discussed above in relation to stage 912 of process 900 shown in FIG. 5, can generate the current number of subframes for each image frame based on the processed pixel intensity values. The generated current number of subframes can be communicated to the output logic 810.

The output logic 810 can adjust display parameters to save power (stage 1014). As discussed above in relation to stage 914 of process 900 shown in FIG. 5, the output logic 810 can reduce power consumption by increasing the duration of one or more of the subframes to utilize any unused time available during displaying a subfield, and reducing the illumination intensity of the backlight. Reducing the illumination intensity of the backlight reduces the power consumption of the display device.

In some implementations, the process of monotonically increasing and subsequently monotonically decreasing of the current number of subframes for first and second sets, respectively, of image frames can be repeated more than once. In some implementations, the repetition can be continuous.

In some other implementations, after displaying the first set and the second set of image frames, the output logic 810 can display subsequent image frames with a full complement of subframes. For example, if prior to the process of monotonically increasing and monotonically decreasing the number of subframes utilized to display the first and second set of image frames the output logic 810 displayed image frames with baseline number of subframes, then after displaying the first set and the second set of image frames, the output logic can return to displaying image frames with the same baseline number of subframes per image frame.

In some other implementations, the process 1000 also can incorporate a scene change detection stage, similar to the scene change detection stage 906 in process 900 discussed above. In some such implementations, if a scene change is detected in an image frame, the process 1000 can interrupt the process, and display the subsequent image frame with a reduced number of subframes equal to the minimum number of subframes used in the process 1000. Thereafter, the process 1000 can recommence the process of monotonically increasing and monotonic decreasing the number of subframes displayed for subsequently received series of image frames, starting with the reduced number of subframes.

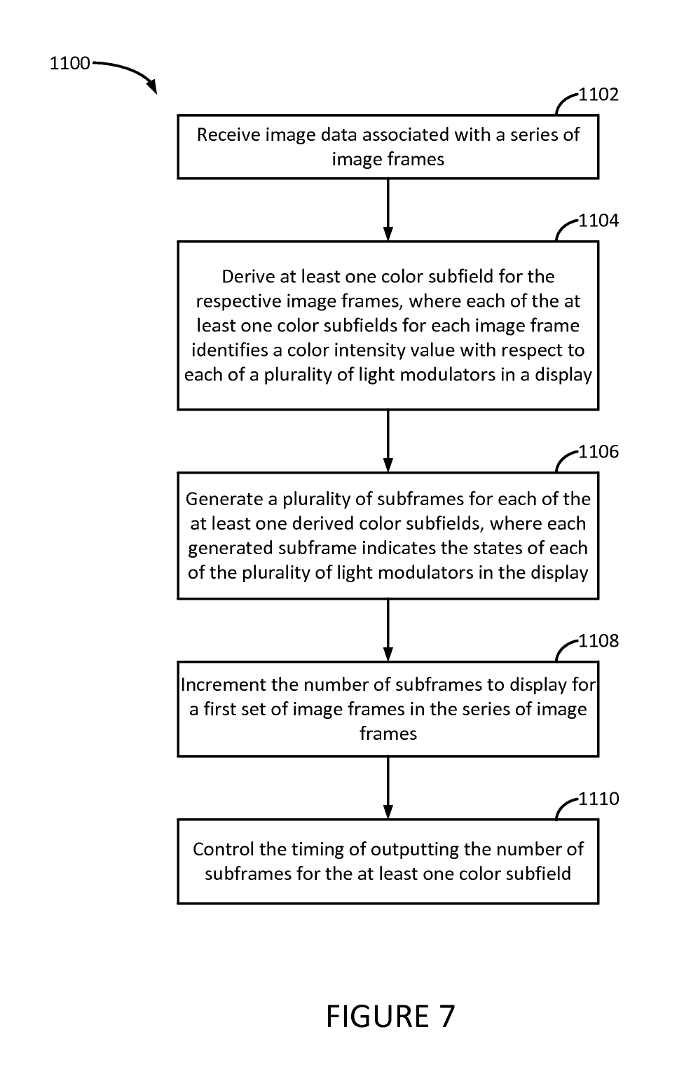

FIG. 7 shows an example flow diagram of another example process 1100 for generating an image on a display. In particular, the process 110 shown in FIG. 7 includes receiving image data associated with a series of image frames (stage 1102): deriving at least one color subfield for the respective image frames, where each of the at least one color subfields for each image frame identifies a color intensity value with respect to each of a plurality of light modulators in a display (stage 1104): generating a plurality of subframes for each of the at least one derived color subfields, where each generated subframe indicates the states of each of the plurality of light modulators in the display (stage 1106): incrementing the number of subframes to generate for a first set of image frames in the series of image frames (stage 1108): and controlling the timing of outputting the number of subframes for the at least one color subfield (stage 1110).

The process 1100 includes receiving image data associated with a series of image frames (stage 1102). Examples of this stage have been discussed above in relation to FIGS. 3-6. Specifically, as shown in FIG. 3, the control logic 706 receives a series of image frames in the form of image frame data from the host device 702. Similarly, FIG. 4 shows the input logic 802 receiving image data associated with an image frame. Furthermore, in FIGS. 5 and 6, stages 902 and 1002 discuss receiving image data associated with a series of image frames.

The process 1100 also includes deriving at least one color subfield for the respective image frames, where each of the at least one color subfields for each image frame identifies a color intensity value with respect to each of a plurality of light modulators in a display (stage 1104). One example of this process stage has been discussed above in relation to FIG. 4. Specifically, the subfield generation logic 804, in one example, derives the set of color subfields by segregating the pixel intensity values (or the color intensity values) for a set of colors (such as red, green, blue and white). Additional examples of this process stage have been discussed above in relation to FIGS. 5 and 6. Specifically, in stages 904 and 1004 of FIGS. 5 and 6, respectively, color subfields are derived by segregating the pixel intensity value for each primary color represented in the received image data.

The process 1100 also includes generating a plurality of subframes for each of the at least one derived color subfields, where each generated subframe indicates the states of each of the plurality of light modulators in the display (stage 1106). Examples of this process stage have been discussed above in relation to FIGS. 4-7. Specifically, the subframe generation logic 808, shown in FIG. 4, generates a current number of subframes for each of the processed subfields based on the input received from the output logic 810. Furthermore, stages 912 and 1012 shown in FIGS. 5 and 6, respectively, discuss generating the current number of subframes for the processed subfields based on input from the output logic 810. In some implementations, the output logic 810 can specify generating a reduced number of subframes, such as when an image frame belongs to a first set of image frames.

The process 1100 also includes incrementing the number of subframes to display for a first set of image frames in the series of image frames (stage 1108). In some implementations, incrementing the number of subframes can include monotonically incrementing the number of subframes. One example of this process stage has been discussed above in relation to FIG. 5. Specifically, stage 908 of FIG. 5 discusses monotonically increasing the number of subframes for a series of received image frames. In some implementations, the number of subframes can be monotonically increased for a first set of image frame that follow a scene change. Another example of this process is discussed in relation to stage 1008 shown in FIG. 6, in which the number of subframes is increased monotonically for a series of received image frames.

The process 1100 also includes controlling the timing of outputting the number of subframes for the at least one color subfield (stage 1110). Examples of this process stage have been discussed above in relation to FIGS. 4-6. Specifically, as discussed above in relation to stages 914 and 1014 shown in FIGS. 5 and 6 respectively, the output logic 810 shown in FIG. 4 controls the timing of one or more subframes during a subfield. Controlling the timing of the subframes can include using the time that was unutilized due to the reduction in the current number of subframes to adjust the timing of the remaining subframes to provide improved power efficiency.

FIGS. 8A and 8B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 8A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIGS. 8A and 8B, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, ac, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus, comprising:
an input capable of receiving image data associated with a series of image frames in a video sequence;
subfield derivation logic capable of, for each of the image frames in the video sequence, deriving at least one color subfield, wherein each of the at least one color subfields for each image frame identifies a color intensity value with respect to each of a plurality of display elements in a display;
subframe generation logic capable of generating a number of subframes for each of the color subfields derived from the image frames in the video sequence, wherein each generated subframe indicates the states of each of the plurality of display elements in the display; and
output logic capable of:
outputting to the subfield derivation logic and the subframe generation logic a monotonically increasing number of subframes to generate for a first set of the image frames; and
controlling the timing of outputting the subframes generated by the subframe generation logic.

2. The apparatus of claim 1, further comprising scene change detection logic capable of detecting a scene change within the video sequence, wherein the first set of image frames includes image frames immediately following a detected scene change.

3. The apparatus of claim 1, wherein the output logic is capable of outputting a monotonically decreasing number of subframes to generate for a second set of the image frames.

4. The apparatus of claim 1, wherein the output logic is capable of outputting a number of subframes to generate equal to a full complement of subframes for a second set of image frames to be displayed subsequent to the display of the first set of image frames.

5. The apparatus of claim 1, wherein the subfield derivation logic is further capable of processing at least one color subfield, based on the number of subframes to generate output by the output control logic, to derive a processed color subfield, and the subframe generation logic is capable of generating subframes for the color subfield based on the processed color subfield.

6. The apparatus of claim 5, wherein processing the color subfield to derive a processed color subfield includes:
obtaining, for each color intensity value in the color subfield, an updated color intensity value based on the number of subframes to generate; and
processing the updated color intensity values with an error distribution process to generate a set of spatially-dithered color intensity values.

7. The apparatus of claim 1, further comprising:
a display including the plurality of display elements;
a processor that is capable of communicating with the display, the processor being capable of processing image data; and
a memory device that is capable of communicating with the processor.

8. The apparatus of claim 7, the display further including:
a driver circuit capable of sending at least one signal to the display; and
a controller capable of sending at least a portion of the image data to the driver circuit.

9. The apparatus of claim 7, the display further including:
an image source module capable of sending the image data to the processor, wherein the image source module includes at least one of a receiver, transceiver and a transmitter; and
an input device capable of receiving input data and to communicate the input data to the processor.

10. A method of forming an image on a display, comprising:
receiving image data associated with a series of image frames;
deriving at least one color subfield for the respective image frames, wherein each of the at least one color subfields for each image frame identifies a color intensity value with respect to each of a plurality of light modulators in a display;
generating a plurality of subframes for each of the at least one derived color subfields, wherein each generated subframe indicates the states of each of the plurality of light modulators in the display;
monotonically increasing the number of subframes to be displayed for a first set of image frames in the series of image frames; and
controlling the timing of outputting the number of subframes for the at least one color subfield.

11. The method of claim 10, further comprising detecting a scene change in the series of image frames and selecting the first set of image frames from image frames following the detected scene change.

12. The method of claim 10, further comprising monotonically decreasing the number of subframes to generate for a second set of image frames in the series of image frames.

13. The method of claim 10, further comprising generating a full complement of subframes for a third set of image frames, in the series of image frames, to be displayed subsequent to the display of the first set of image frames.

14. The method of claim 10, further comprising:
processing at least one color subfield based on the number of subframes to derive a processed color subfield, wherein the processed color subfield includes processed color intensity values based on the number of subframes to generate,
wherein generating the plurality of subframes for each of the at least one derived color subfields includes generating the plurality of subframes for each of the processed color subfields.

15. The method of claim 10, wherein monotonically increasing the number of subframes to be displayed includes monotonically increasing subframes corresponding to one of the at least one derived color subfield at a different rate than for at least one other of the at least one derived color subfield.

16. A non-transitory computer readable storage medium having instructions encoded thereon, which when executed by a processor cause the processor to perform a method for displaying an image, comprising:
receiving image data associated with a series of image frames;
deriving at least one color subfield for the respective image frames, wherein each of the at least one color subfields for each image frame identifies a color intensity value with respect to each of a plurality of light modulators in a display;
generating a plurality of subframes for each of the at least one derived color subfields, wherein each generated subframe indicates the states of each of the plurality of light modulators in the display;
monotonically increasing the number of subframes to be displayed for a first set of image frames in the series of image frames; and
controlling the timing of outputting the number of subframes for the at least one color subfield.

17. The non-transitory computer readable storage medium of claim 16, wherein the method further includes detecting a scene change in the series of image frames and selecting the first set of image frames from image frames following the detected scene change.

18. The non-transitory computer readable medium of claim 17, wherein the method further includes monotonically decreasing the number of subframes to be displayed for a second set of image frames in the series of image frames.

19. The non-transitory computer readable medium of claim 16, wherein the method further includes generating a full complement of subframes for a third set of image frames, in the series of image frames, to be displayed subsequent to the display of the first set of image frames.

20. The non-transitory computer readable medium of claim 16, wherein the method further includes
processing at least one color subfield based on the number of subframes to derive a processed color subfield, wherein the processed color subfield includes processed color intensity values based on the number of subframes to generate, and
wherein generating the plurality of subframes for each of the at least one derived color subfields includes generating the plurality of subframes for each of the processed color subfields
